(19) United States
(12) Patent Application Publication
(10) Pub. No.: US 2026/0295713 A1
(43) Pub. Date: Oct. 1, 2026

(54) BED MESH ASSEMBLY DEVICE AND BED MESH ASSEMBLY METHOD

(71) Applicant: Guangzhou Lianrou Machinery & Equipment Co., Ltd, Guangzhou City (CN)

(72) Inventors: Zhiliang TAN, Guangzhou City (CN); Huagui LI, Guangzhou City (CN); Shanmei LIAO, Guangzhou City (CN); Zhiming TAN, Guangzhou City (CN); Jie LIANG, Guangzhou City (CN)

(73) Assignee: Guangzhou Lianrou Machinery & Equipment Co., Ltd, Guangzhou City (CN)

(21) Appl. No.: 19/410,188

(22) Filed: Dec. 5, 2025

(30) Foreign Application Priority Data
Mar. 25, 2025 (CN) 2025103565844

(51) Int. Cl. B23K 20/10; A47C 27/07

(52) U.S. Cl. CPC B23K 20/10; A47C 27/07

(57) ABSTRACT

A bed mesh assembly device includes: a plurality of welding blade mechanisms arranged along a first direction, wherein one side of each of the welding blade mechanisms is formed with a welding station, each of the welding blade mechanisms comprises two welding blade assemblies, each of the welding blade assemblies comprises a plurality of welding blades extending along the first direction, the welding blades in a same welding blade assembly are spaced apart along a second direction, the welding blades in different welding blade assemblies are alternately arranged along the second direction to respectively correspond to positions between adjacent springs of a spring string, and the two welding blade assemblies alternately withdraw between two adjacent rows of the spring string and move to one side of the spring string near the welding station.

### CROSS-REFERENCE TO RELATED APPLICATION

This application is based on and claims the benefit of priority from Chinese Patent Application No. 202510356584.4, filed on Mar. 25, 2025, the entirety of which is incorporated by reference herein.

### TECHNICAL FIELD

The present disclosure relates to the technical field of automated production, and more particularly, to a bed mesh assembly device and a bed mesh assembly method.

### BACKGROUND

A main component of a spring mattress is a spring bed mesh, which is typically manufactured by first connecting a plurality of springs in sequence to form a pocketed spring string, followed by welding these spring strings side by side. For example, a connecting fabric between two adjacent springs in the spring strings serves as a welding position. A welding blade and a welding head work together to bond the fabrics at the welding positions of adjacent spring strings, thereby joining and securing two rows of spring strings.

Typically, the welding positions between the two adjacent rows of the spring string are staggered. During welding, the first row of spring string is laid first, and first welding positions of the spring string are welded. Then, the second row of spring string is laid, and second welding positions of the spring string are welded. The first welding positions and the second welding positions are staggered, enabling the spring bed mesh to be welded and formed through this welding process. However, during the process of laying the spring strings, the welding head is required to disengage from the welding blade. Only after the spring strings are properly laid, can the welding head reconnect with the welding blade. This process involves an idle time for the welding head while waiting, thus leading to time waste, which is not beneficial for improving a welding speed and a bed mesh production efficiency.

### SUMMARY

In order to solve at least one of the above technical problems, the present disclosure provides a bed mesh assembly device and a bed mesh assembly method, which can save the waiting time of welding heads and improve the welding efficiency. The present disclosure adopts the technical solutions as follows.

In a first aspect, a bed mesh assembly device is provided according to an embodiment of the present disclosure, including:
a plurality of welding blade mechanisms arranged along a first direction, wherein one side of each of the welding blade mechanisms is formed with a welding station, each of the welding blade mechanisms includes two welding blade assemblies, each of the welding blade assemblies includes a plurality of welding blades extending along the first direction, the welding blades in a same welding blade assembly are spaced apart along a second direction, the welding blades in different welding blade assemblies are alternately arranged along the second direction to respectively correspond to positions between adjacent springs of a spring string, and the two welding blade assemblies alternately withdraw between two adjacent rows of the spring string and move to one side of the spring string near the welding station;
a welding head mechanism, wherein the welding head mechanism is movable along the first direction to any of the welding stations, the welding head mechanism includes a plurality of welding head assemblies spaced apart along the second direction, and the welding head assemblies are capable of performing welding cooperatively with any of the welding blade assemblies; and
a loading assembly for moving along the second direction to convey the spring string to the welding station;
wherein the at least one loading assembly is configured to, in response to the welding head mechanism moving to any of the welding stations, convey the spring string to remaining welding stations.

In some embodiments of the present disclosure, the bed mesh assembly device includes two loading assemblies and the loading assembly is one of the two loading assemblies, the plurality of welding blade mechanisms includes two welding blade mechanisms, and the loading assemblies and the welding blade mechanisms are arranged in one-to-one correspondence.

In some embodiments of the present disclosure, the loading assembly includes conveying parts, the conveying parts are arranged spaced apart in the second direction or a third direction in pairs, at least part of a loading channel is defined between the conveying parts in pairs, at least one of the conveying parts is a driving part, the driving part includes at least one of a thumbwheel, a roller or a conveyor belt, and the driving part is movable to convey the spring string.

In some embodiments of the present disclosure, a distance between the conveying parts in pairs is adjustable to be suitable for spring strings with different diameters.

In some embodiments of the present disclosure, the loading assembly further includes a guiding structure, the guiding structure is arranged on a loading side of the conveying parts, the guiding structure includes two first guiding components which are arranged on both sides of the spring string along a radial direction of the springs, and a space between the two first guiding components is formed as the loading channel; and/or
the guiding structure includes a second guiding component which is arranged on an end face of the spring string along the radial direction of the springs, and one side of the second guiding component facing the spring string is formed as a part of the loading channel.

In some embodiments of the present disclosure, each of the welding blade assemblies is movable in a third direction, and each of the welding blade assemblies is configured to push the spring string away from the welding head mechanism in the third direction in response to the welding blade assembly withdrawing from the spring string in the first direction and moving in the third direction to one side of the spring string facing the welding head mechanism.

In some embodiments of the present disclosure, the bed mesh assembly device further includes a plurality of limiting assemblies, each of the limiting assemblies is arranged on one side of a respective one of the welding blade mechanisms away from the welding station along the third direction, surfaces of each of the limiting assemblies are formed as a forming channel for a welded bed mesh to pass through.

In some embodiments of the present disclosure, each of the limiting assemblies includes a first bearing part and a second bearing part which are arranged at an interval along the first direction, the forming channel is defined between the first bearing part and the second bearing part, both the first bearing part and the second bearing part extend along the second direction, a distance between the first bearing part and the second bearing part is adjustable, and each of the welding blade assemblies is configured to be abutted against the respective first bearing part and the respective second bearing part in response to the welding head mechanism applying a force on the respective welding blade assembly.

In some embodiments of the present disclosure, each of the limiting assemblies further includes a plurality of supporting parts arranged spaced apart along the second direction, the supporting parts are arranged on one side of each of the first bearing part and the second bearing part facing the welding head mechanism, the supporting parts are arranged in gaps between adjacent welding blades, the supporting parts extend into the welding station along the third direction, and the supporting parts are configured for accommodating the spring string laid by the loading assembly.

In some embodiments of the present disclosure, both the first bearing part and the second bearing part are limiting plates, the supporting parts are clamped to the limiting plates, and intervals of the plurality of supporting parts along the second direction are adjustable.

In some embodiments of the present disclosure, each of the welding blade assemblies includes a first installing base and the plurality of welding blades, one end of each of the welding blades is rotatably connected to the first installing base, the welding blades are rotatable relative to the first installing base when the welding blades are engaged with the welding head assembly, and a back of each of the welding blades is abutted against the limiting plates, so that the welding blades are engaged with the welding head assembly.

In some embodiments of the present disclosure, the welding head assembly is movable in the second direction, so that the welding head assembly is able to perform welding at different positions in a same welding blade mechanism cooperatively with the welding blades at the different positions.

In a second aspect, a bed mesh assembly method is provided according to an embodiment of the present disclosure, including:
performing welding by a welding head mechanism in cooperation with a first welding blade mechanism; and at the same time, laying, by a loading assembly, a spring string on a welding station of a second welding blade mechanism;
switching the welding head mechanism from the first welding blade mechanism to the welding station of the second welding blade mechanism;
performing welding by the welding head mechanism in cooperation with the second welding blade mechanism; and at the same time, laying, by a further loading assembly, a further spring string on a welding station of the first welding blade mechanism; and
switching the welding head mechanism from the second welding blade mechanism to the welding station of the first welding blade mechanism.

In some embodiments of the present disclosure, the performing welding by a welding head mechanism in cooperation with a first welding blade mechanism includes: performing welding by the welding head mechanism in cooperation with one of welding blade assemblies of the first welding blade mechanism; and performing welding by the welding head mechanism in cooperation with another one of the welding blade assemblies of the first welding blade mechanism; and
the performing welding by the welding head mechanism in cooperation with the second welding blade mechanism includes: performing welding by the welding head mechanism in cooperation with one of welding blade assemblies of the second welding blade mechanism; and performing welding by the welding head mechanism in cooperation with another one of the welding blade assemblies of the second welding blade mechanism.

In some embodiments of the present disclosure, a quantity of welding heads of the welding head mechanism is less than a quantity of welding blades of the welding blade mechanism, performing welding by the welding head mechanism in cooperation with the respective welding blade mechanism includes:
performing welding by the welding head mechanism in cooperation with a part of the welding blades of the respective welding blade mechanism;
moving the welding head mechanism in a second direction, and performing welding by the welding head mechanism in cooperation with remaining welding blades of the respective welding blade mechanism; and
repeating the previous step until the welding head mechanism performs welding in cooperation with all the welding blades.

The embodiments of the present disclosure at least have the following beneficial effects. The loading assembly and the welding head mechanism work alternately, and when the welding head mechanism performs welding cooperatively with the first welding blade mechanism, the loading assembly conveys the spring string to other welding station. When the welding head mechanism completes welding, the welding head mechanism is separated from the first welding blade mechanism and switched to the second welding blade mechanism in the first direction for welding. Using a welding time with the second welding blade mechanism, the loading assembly lays the spring string on the first welding blade mechanism. After welding cooperatively with the second welding blade mechanism, the welding head mechanism is switched to cooperate with the first welding blade mechanism and can weld immediately without waiting for loading, thus saving and shortening a waiting time of the welding head mechanism in the process of laying the spring string, helping to reduce the waste of time, further improving a welding speed and improving an assembly efficiency of a bed mesh.

### BRIEF DESCRIPTION OF THE DRAWINGS

The present disclosure will be further described in detail below with reference to the accompany drawings and specific embodiments. It should be noted that the embodiments described below with reference to the accompanying drawings are exemplary and are only intended to explain the present disclosure, but should not be construed as limiting the present disclosure.

FIG. 1 is a schematic structural diagram of an example of a bed mesh assembly device provided by embodiments of the present disclosure;

FIG. 2 is a schematic structural diagram of another example of the bed mesh assembly device provided by the embodiments of the present disclosure;

FIG. 3 is a front view of the bed mesh assembly device provided by the embodiments of the present disclosure;

FIG. 4 is a schematic structural diagram of the bed mesh assembly device provided by the embodiments of the present disclosure after a limiting assembly is hidden;

FIG. 5 is a schematic structural diagram of the bed mesh assembly device provided by the embodiments of the present disclosure from another perspective;

FIG. 6 is a side view of the bed mesh assembly device provided by the embodiments of the present disclosure;

FIG. 7 is a schematic diagram of a welding process of the bed mesh assembly device provided by the embodiments of the present disclosure from a top view; and

FIG. 8 is a flow chart of a bed mesh assembly method provided by the embodiments of the present disclosure.

### REFERENCE NUMERALS

1000—Bed mesh assembly device;

100—welding blade mechanism; 101—welding station; 110—welding blade assembly; 111—welding blade; 1111—first welding blade; 1112—second welding blade; 113—first installing base;

200—welding head mechanism; 210—welding head assembly; 211—welding head; 212—welding head driver;

300—limiting assembly; 301—forming channel; 310—first bearing part; 320—second bearing part; 340—supporting part;

400—loading assembly; 401—loading channel; 410—conveying part; 420—guiding structure; 421—first guiding component; 422—second guiding component;

610—first rail; 620—second driving component;

910—first welding position; 920—second welding position;

2000—spring string; and

3000—bed mesh.

### DETAILED DESCRIPTION OF THE EMBODIMENTS

The embodiments of the present disclosure will be described in detail hereinafter with reference to the drawings, and the same or similar reference numerals throughout the drawings denote the same or similar elements or elements having the same or similar functions. The embodiments described hereinafter with reference to the drawings are exemplary, are only intended to explain the present disclosure, and cannot be understood as limiting the present disclosure.

In the description of the present disclosure, it should be understood that, the orientation or position relationship related to the orientation description, such as the orientation or position relationship indicated by the terms such as “center”, “middle”, “longitudinal”, “transversal”, “length”, “width”, “thickness”, “up”, “down”, “front”, “back”, “left”, “right”, “vertical”, “horizontal”, “top”, “bottom”, “inside”, “outside”, “axial”, “radical”, “circumferential” is based on the orientation or position relationship shown in the drawings, which is only used for convenience of the description of the present disclosure and simplification of the description instead of indicating or implying that the indicated device or element must have a specific orientation, and be constructed and operated in a specific orientation, and thus should not be understood as a limitation to the present disclosure.

In the description of the present disclosure, the term “several” refers to being one or more, the term “a plurality of” refers to being two or more, and the terms such as “greater than”, “less than”, “more than” are understood as not including the specified number, while the terms such as “above”, “below”, “within” are understood as including the specified number. If there is a description to the first and second, it is only for the purpose of distinguishing between technical features, and shall not be understood as indicating or implying relative importance, implicitly indicating the number of the indicated technical features or implicitly indicating the order of the indicated technical features.

In the description of the present disclosure, unless expressly stipulated and defined otherwise, terms such as “arrangement”, “installation”, “connected” and “connection” should be understood broadly, for example, may either be fixed connection or detachable connection, and may also be integral connection; may also be mechanical connection or electrical connection; and may be direct connection, may also be indirect connection through an intermediate medium, and may be communication inside two elements. The specific meaning of the above terms in the present disclosure can be understood in a specific case by those of ordinary skills in the art.

In the description of the present disclosure, the descriptions with reference to the terms such as “an embodiment”, “one embodiment”, “some examples”, “some embodiments”, “illustrative embodiments”, “examples”, “specific examples” or “several examples” mean that the specific features, structures, materials or characteristics described in connection with this embodiment or example are included in at least one embodiment or example of the present disclosure. In this specification, the schematic representation of the above terms does not necessarily refer to the same embodiment or example. Moreover, the specific features, structures, materials or characteristics described may be combined in any one or more embodiments or examples in a suitable manner. In this specification, the schematic representation of the above terms does not necessarily refer to the same embodiment or example. Moreover, the specific features, structures, materials or characteristics described may be combined in any one or more embodiments or examples in a suitable manner.

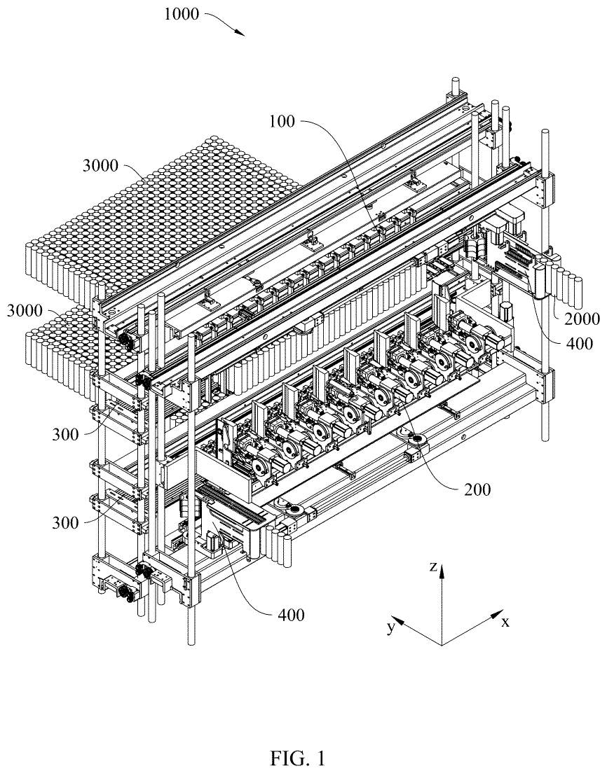

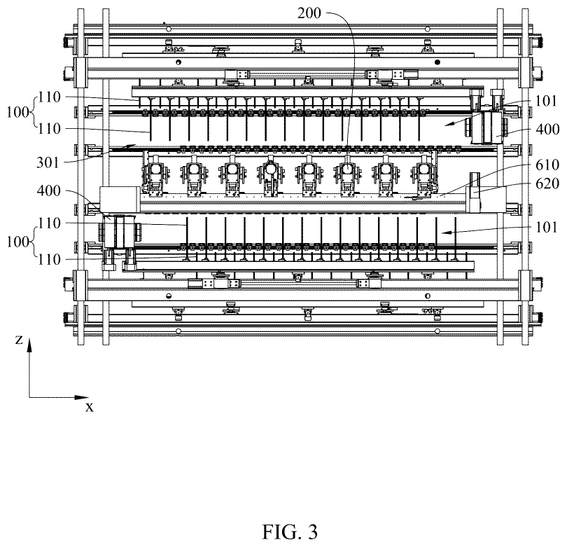

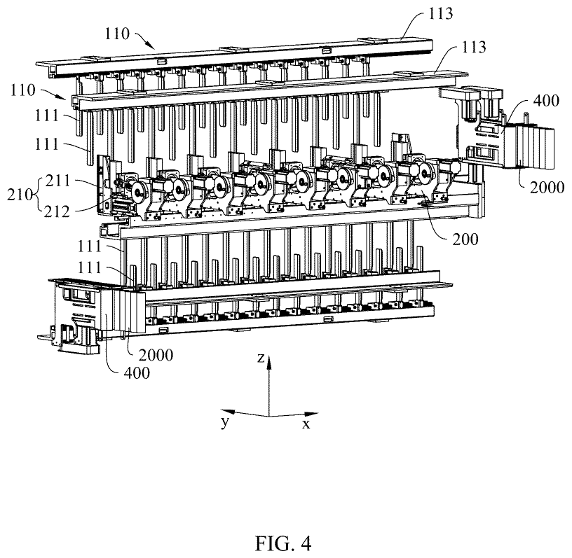

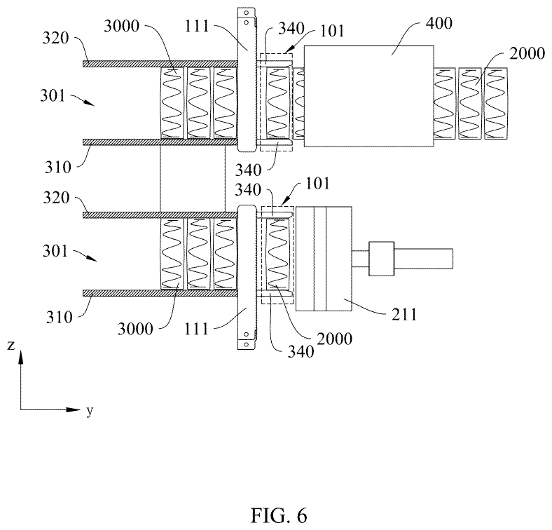

Referring to FIG. 1 to FIG. 6, a first aspect of the present disclosure provides a bed mesh assembly device 1000, including a loading assembly 400, a welding head mechanism 200 and a plurality of welding blade mechanisms 100. As for the plurality of welding blade mechanisms 100 arranged in a first direction (a z direction shown in FIG. 1), one side of each of the welding blade mechanisms 100 is formed with a welding station 101. The welding blade mechanism 100 includes two welding blade assemblies 110, and each of the welding blade assemblies 110 includes a plurality of welding blades 111 extending in the first direction. The welding blades 111 in the same welding blade assembly are spaced apart in a second direction (an x direction shown in FIG. 1), and the welding blades 111 of different welding blade assemblies are alternately arranged in the second direction to respectively correspond to positions between adjacent springs of a spring string 2000. The two welding blade assemblies 110 alternately withdraw between two adjacent rows of the spring string 2000 and move to one side of the spring string 2000 near the welding station 101. The welding head mechanism 200 movable in the first direction to any welding station 101. The welding head mechanism 200 includes a plurality of welding head assemblies 210 spaced apart in the second direction, and the welding head assemblies 210 are capable of performing welding cooperatively with any of the welding blade assemblies 110. The loading assembly 400 is used for moving in the second direction to convey the spring string 2000 to the welding station 101. When the welding head mechanism 200 moves to any of the welding stations 101, the loading assembly 400 conveys the spring string 2000 to the remaining welding stations 101.

In the present disclosure, the loading assembly 400 and the welding head mechanism 200 work alternately. When the welding head mechanism 200 operates cooperatively with the welding blade mechanism 100 at any welding station 101 (taking FIG. 1 as an example, hereinafter defined as a first welding blade mechanism) for welding, the loading assembly 400 conveys the spring string 2000 to other welding stations 101. When the welding head mechanism 200 completes welding, the welding head mechanism 200 is separated from the first welding blade mechanism and switched to another welding blade mechanism 100 (hereinafter referred to as a second welding blade mechanism) in the first direction for welding. Using the time period during welding with the second welding blade mechanism, the loading assembly 400 lays the spring string 2000 on the first welding blade mechanism. After welding with the second welding blade mechanism, the welding head mechanism 200 is switched to cooperate with the first welding blade mechanism and can weld immediately without waiting for loading, thus saving and shortening a waiting time of the welding head mechanism 200 in the process of laying the spring string 2000, helping to reduce the waste of time, further improving a welding speed and improving an assembly efficiency of a bed mesh 3000.

Taking FIG. 1 as an example, the first direction is a vertical direction, and the first direction, the second direction and a third direction are perpendicular to each other.

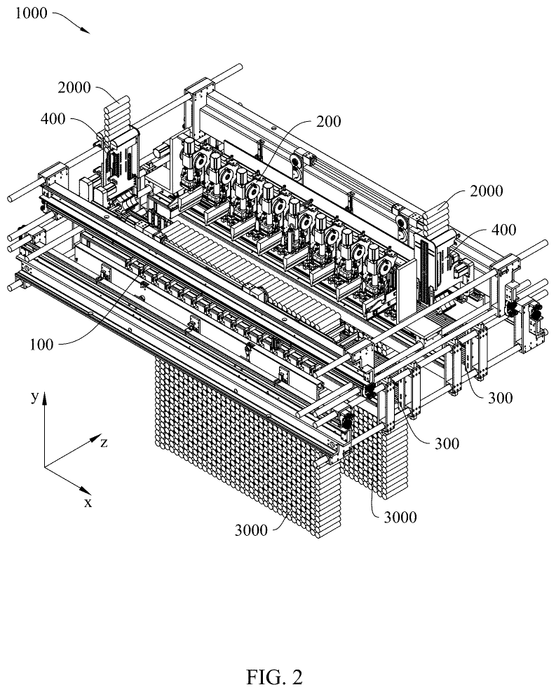

Of course, in other examples, the first direction may also be a horizontal direction, while the third direction serves as the vertical direction, as shown in FIG. 2. In the example of FIG. 2, a bed mesh 3000 is formed by welding in the vertical direction. Specifically, the plurality of welding blade mechanisms 100 are distributed in the first direction (z direction shown in FIG. 2), and the welding head mechanism 200 moves close to or far away from the welding blade assembly 110 in the third direction (y direction shown in FIG. 2). That is, the welding blade assembly 110 is arranged horizontally and below the welding head mechanism 200, and the welding station 101 is arranged vertically upward. In this case, after the welding blade assembly 110 withdraws from the spring string 2000 in the horizontal direction, the spring string 2000 may move downward by gravity thereof, or the spring string 2000 may be pressed downward by additional pressing plates or pressing rods distributed at intervals, and then the welding blade assembly 110 returns to one side of the spring string 2000 near the welding station 101 in the horizontal direction, so that the welding blade assembly 110 only needs to reciprocate in the horizontal direction.

When the welding blade assembly 110 is arranged vertically as shown in FIG. 1, after the welding blade assembly 110 withdraws from the spring string 2000 in the first direction, the spring string 2000 may be pushed away from the welding station 101 by additional pressing plates or pressing rods distributed at intervals, and then the welding blade assembly 110 returns to one side of the spring string 2000 near the welding station 101 in the first direction, so that the welding blade assembly 110 only needs to reciprocate in the first direction.

The above two examples show two different layout modes of the first direction, the second direction and the third direction, and the layout modes of these three directions are not specifically limited in the present disclosure. The following description will continue with the components form in FIG. 1 as an example.

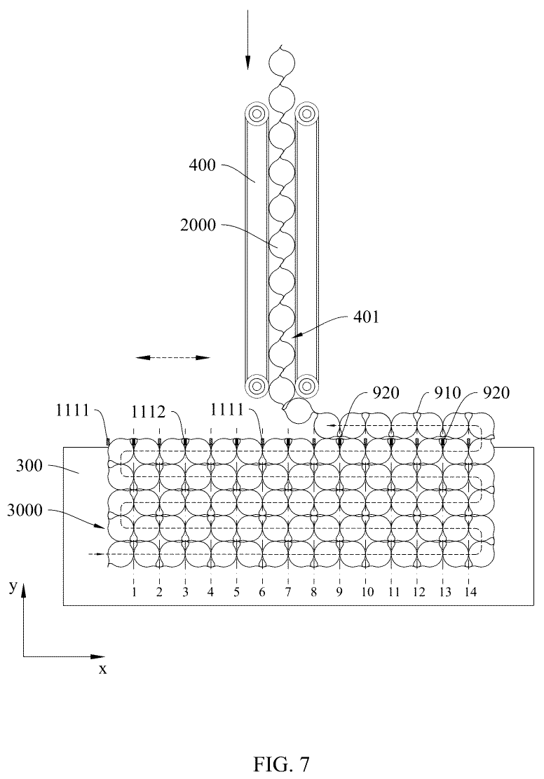

Alternatively, the two welding blade assemblies 110 alternately weld different welding positions of the spring string 2000. Specifically, with reference to FIG. 1 and FIG. 7, welding of one bed mesh 3000 is taken as an example for explanation. In FIG. 7, the welding positions in each row of the spring string 2000 are identified by indicator lines with numerical numbers, and a laying sequence of each row of the spring string 2000 in the bed mesh 3000 is also identified by an indicator line with an arrow. As shown in FIG. 7, in one row of the spring string 2000, the welding positions may be further divided into first welding positions 910 (that is, the welding positions identified by the indicator lines with even numerical numbers) and second welding positions 920 (that is, the welding positions identified by the indicator lines with odd numerical numbers). The first welding positions 910 and the second welding positions 920 alternate with each other. The first row of the spring string 2000 and the second row of the spring string 2000 are welded through the first welding positions 910. The second row of the spring string 2000 and the third row of the spring string 2000 are welded through the second welding positions 920.

The loading assembly 400 lays each row of the spring string 2000 in turn. Starting from the second row of the spring string 2000, once each row of the spring string 2000 is laid, the welding head assembly 210 and the welding blade assembly 110 weld the laid row of the spring string 2000 and the previous row of the spring string 2000 together. The two welding blade assemblies 110 correspond to the first welding positions 910 and the second welding positions 920 of the spring string 2000 respectively. In the welding process, firstly, the welding blades 111 of the first welding blade assembly 110 (hereinafter defined as the first welding blades 1111) correspond to the first welding positions 910, and the loading assembly 400 lays the even-numbered row of the spring string 2000 on the odd-numbered row of the spring string 2000, and the welding head assembly 210 presses the welding station 101. The welding head assembly 210 and the first welding blades 1111 clamp and weld the first welding positions 910 of the two rows of the spring string 2000 together. Next, the welding blades 111 of the second welding blade assembly 110 (hereinafter referred to as second welding blades 1112) correspond to the second welding positions 920, and the loading assembly 400 lays the odd-numbered row of the spring string 2000 on the even-numbered row of the spring string 2000, and the welding head assembly 210 presses the welding station 101. The welding head assembly 210 and the second welding blades 1112 clamp and weld the second welding positions 920 of the two rows of the spring string 2000 together. On one hand, the loading assembly 400 can continuously lay one row of the spring string 2000, and the welding head assembly 210 can perform welding after the laying of one row of the spring string 2000 is completed. On the other hand, the two welding blade assemblies 110 alternately cooperate with the welding head assembly 210 to complete welding, thus improving a production efficiency of the bed mesh 3000.

Illustratively, the welding head assembly 210 includes a welding head 211 and a welding head driver 212. The welding head driver 212 drives the welding head 211 to extend and connect with the welding blade 111 to realize welding, and the welding head driver 212 drives the welding head 211 to retract and separate from the welding blade 111. The welding head 211 may be an ultrasonic welding head 211, a thermal welding head 211 or the like.

Alternatively, taking FIG. 1 for example, the bed mesh assembly device 1000 is provided with two welding blade mechanisms 100. The two welding blade mechanisms 100 are arranged in the first direction. Of course, in other examples, three, four or more welding blade mechanisms 100 may be provided in the first direction, which is not limited here. In the following, the description will be continued by taking the setting of two welding blade mechanisms 100 as an example.

In some embodiments, two loading assemblies 400 and two welding blade mechanisms 100 are provided, and the loading assemblies 400 and the welding blade mechanisms 100 are arranged in one-to-one correspondence. In this way, the two loading assemblies 400 may be used to feed the welding stations 101 on each of the welding blade mechanisms 100 independently, and loading requirements of the two welding blade mechanisms 100 can be met without moving the loading assembly 400 in the first direction, thus further improving a laying efficiency of the spring string 2000. In this process, because a welding operation and a loading operation in the welding station 101 are always alternately performed, the loading mechanism stops at one end of the welding blade assembly 110 of the second direction during welding, which can avoid interference with the welding head mechanism 200.

As an alternative embodiment, one loading assembly 400 may also be provided. After laying the spring string 2000 for one welding blade mechanism 100, the loading assembly 400 may be switched to the position of the other welding blade mechanism 100 in the first direction for loading.

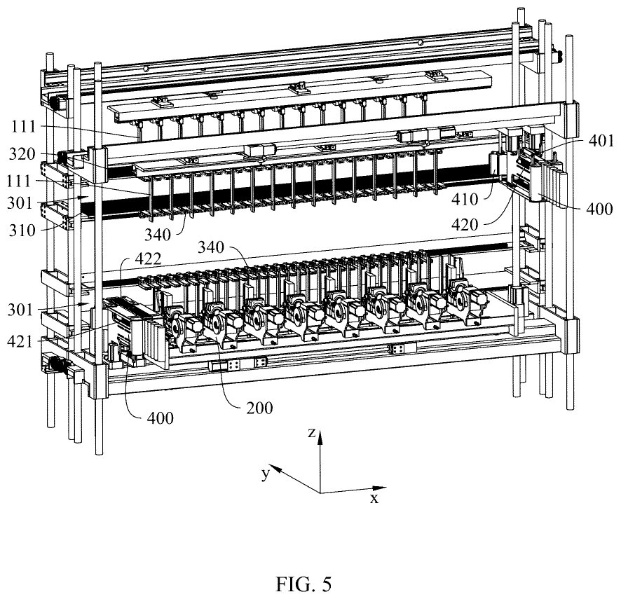

In some embodiments, the loading assembly 400 includes conveying parts 410, and the conveying parts 410 are arranged spaced apart in the second direction or the third direction (a y direction shown in FIG. 5) in pairs. At least part of a loading channel 401 is defined between the conveying parts 410 in pairs, at least one of the conveying parts 410 is a driving part, the driving part includes at least one of a thumbwheel, a roller or a conveyor belt, and the driving part is movable to convey the spring string 2000. The movement of the spring string 2000 is driven by rotation of the driving part and a frictional interaction between a surface of the driving part and a surface of the spring string 2000, thereby enabling a laying motion of the spring string 2000. The driving part may take the form of a thumbwheel (as shown in the example in FIG. 5), and adjacent cams of the thumbwheel create grooves that can be clamp a periphery of the respective springs. Under a rotating action of the thumbwheel, the spring string 2000 is conveyed. Alternatively, the roller or the conveyor belt may also be used. The conveying parts 410 arranged in pairs may both be arranged as the driving parts, that is, power may be provided for two conveying parts 410, or in other examples, one conveying part 410 may be arranged as the driving part and the other as a driven part, which is not specifically limited here.

In some embodiments, a distance between the conveying parts 410 in pairs is adjustable to be suitable for spring strings 2000 with different diameters. For the spring strings 2000 with different diameters, by adjusting the distance between the two conveying parts 410 arranged in pairs, assembly requirements of bed meshes with different sizes and models can be met, and the versatility of the loading assembly 400 can be improved. Alternatively, the distance between the conveying parts 410 in pairs may be adjusted manually or by electric adjustment, which is not limited here.

Alternatively, when the conveying part 410 is in a form of a conveyor belt, the conveyor belt may extend in a conveying direction of the spring string 2000, which plays a role in guiding and limiting the spring string 2000 in the laying process. In this way, the conveying part 410 can not only provide power for the movement of the spring string 2000, but also guide the spring string 2000. Of course, in other examples, a guiding structure 420 may be additionally arranged in the loading assembly 400 to achieve a guiding effect on the spring string 2000.

In some embodiments, the loading assembly 400 further includes a guiding structure 420. The guiding structure 420 is arranged on a loading side of the conveying parts 410, the guiding structure 420 includes two first guiding components 421 which are arranged on both sides of the spring string 2000 in a radial direction of the springs, and a space between the two first guiding components 421 is defined as the loading channel 401. The first guiding structure 420 can guide the spring in a circumferential direction of the spring, so as to ensure that the spring string 2000 can be smoothly laid on the welding station 101, avoid a situation that the spring string 2000 is twisted, and improve a loading stability and a loading reliability. For example, the first guiding components 421 may be roller shafts, rollers (as shown in FIG. 5), conveyor belts, transmission chains, or the like, arranged in an array.

In some embodiments, the guiding structure 420 includes a second guiding component 422 which is arranged on an end face of the spring string 2000 in the radial direction of the springs, and one side of the second guiding component 422 facing the spring string is formed as a part of the loading channel 401. The guiding structure 420 arranged on the end face of the spring string can play a role in limiting the spring string in the axial direction, avoiding the springs of the spring string 2000 from bouncing and other problems, and improving the loading reliability. Similarly, the second guiding component 422 may be a roller shaft (as shown in FIG. 5), a conveyor belt, a transmission chain, or the like, arranged in an array.

It can be understood that either the first guiding components 421 or the second guiding component 422 may be set. Of course, the first guiding components 421 and the second guiding component 422 may be both set, which is not limited here.

In some embodiments, the welding blade assembly 110 is movable in the third direction, and when the welding blade assembly 110 withdraws from the spring string 2000 in the first direction and moves in the third direction to one side of the spring string 2000 facing the welding head mechanism 200, the welding blade assembly 110 is capable of pushing the spring string 2000 away from the welding head mechanism 200 in the third direction. With a pushing action of the welding blades 111, the spring string 2000 can be pushed out of the welding station 101, freeing the welding station 101 so the next row of the spring string 2000 can be laid down. The welded row of the spring string 2000 can enter the forming channel 301 for temporary storage, and the whole bed mesh 3000 may be transferred out of the forming channel 301 after it is welded. By moving the welding blade assembly 110 in the third direction, the spring string 2000 can be pushed to the forming channel 301 by moving the welding blade assembly 110 in the first direction and the third direction, and the welding blade assembly 110 is switched to one side of the spring string 2000 near the welding station 101. In this process, there is no need to additionally set a pressing rod or a pressing plate for pushing the spring string 2000, which is helpful to simplify a structure of the bed mesh assembly device 1000.

In some embodiments, the bed mesh assembly device 1000 further includes a plurality of limiting assemblies 300. Each of the limiting assemblies 300 is arranged on one side of a respective one of the welding blade mechanisms 100 away from the welding station 101 in the third direction. Surfaces of each of the limiting assemblies 300 are formed as a forming channel 301 for the welded bed mesh 3000 to pass through. The forming channel 301 formed by each limiting assembly 300 can be used to accommodate the welded spring string 2000. After a certain number of rows of the spring string 2000 are welded, one bed mesh 3000 is formed, and the bed mesh 3000 can be output from the forming channel 301. By arranging the plurality of limiting assemblies 300 in one-to-one correspondence with the welding blade mechanisms 100, a plurality of bed meshes 3000 can be accommodated simultaneously. The forming channel 301 can define a relatively independent accommodating space for the bed meshes 3000, so as to avoid the mutual interference of a plurality of bed meshes 3000 in the welding and forming process.

In some embodiments, the limiting assembly 300 includes a first bearing part 310 and a second bearing part 320 which are arranged at an interval in the first direction. The forming channel 301 is formed between the first bearing part 310 and the second bearing part 320. Both the first bearing part 310 and the second bearing part 320 extend in the second direction, and a distance between the first bearing part 310 and the second bearing part 320 is adjustable. When the welding head mechanism 200 exerts a pressure on the respective welding blade assembly 110, the welding blade assembly 110 is capable of being abutted against the first bearing part 310 and the second bearing part 320. By defining the forming channel 301 between the first bearing part 310 and the second bearing part 320, sealing and independence of each forming channel 301 can be improved, interference between the forming channel 301 and other components can be avoided, the welded spring string 2000 can be accommodated in the forming channel 301, and the safety and reliability in a manufacturing process of the bed mesh 3000 can be improved. Adjusting the distance between the first bearing part 310 and the second bearing part 320 is helpful to adjust a height of the forming channel 301, so as to adapt to the spring strings 2000 with different specifications and heights and improve the adaptability to the production of bed meshes 3000 with different specifications. When the welding heads 211 cooperate with and apply a force to the corresponding welding blades 111, the limiting assembly 300 can provide a supporting force to a back of each of the welding blades 111, that is, the limiting assembly 300 is abutted on the back of the welding blade assembly 110, which can make the welding blades 111 more stable when being pressed by the welding heads 211, thereby improving the engagement force between the welding heads 211 and the respective welding blades 111 and contributing to help the welding heads 211 and the respective welding blades 111 to form a better contact, and improving the welding effect.

Exemplarily, the first bearing part 310 may include at least one of a carrier platform, a baffle, a screen, and a conveyor belt. In the embodiment of FIG. 5, the first bearing part 310 is implemented as a baffle (limiting plate).

In some embodiments, each of the limiting assemblies 300 further includes a plurality of supporting parts 340 arranged spaced apart in the second direction. The supporting parts 340 are arranged on one side of each of the first bearing part 310 and the second bearing part 320 facing the welding head mechanism 200. The supporting parts 340 are arranged in gaps between adjacent welding blades 111, and the supporting parts 340 extend into the welding station 101 in the third direction. The supporting parts 340 are configured for accommodating the spring string laid by the loading assembly 400. With the supporting parts 340 extending into the welding station 101, on one hand, the spring string 2000 laid on the welding station 101 can be supported to ensure the stability of the spring string 2000 in the welding process. On the other hand, by arranging the supporting parts 340 and the welding blades 111 in an interleaved manner, mutual interference between the supporting parts 340 and the welding blades 111 can be avoided, and the space of the welding station 101 can be fully utilized, so that the arrangement of the supporting parts 340 and the welding blades 111 is more compact.

In some embodiments, both the first bearing part 310 and the second bearing part 320 are limiting plates, and the supporting parts 340 are clamped to the limiting plates. Intervals of the plurality of supporting parts 340 are adjustable in the second direction. For the spring strings 2000 with different specifications (for example, arrangement densities of the springs are different, and diameters of the springs are different), by adjusting the intervals between the plurality of supporting parts 340, each supporting part 340 can support the respective spring, thus improving the support stability and the adaptability for the spring strings 2000 with different specifications.

In some embodiments, each of the welding blade assemblies 110 includes a first installing base 113 and a plurality of welding blades 111. One end of each of the welding blades 111 is rotatably connected to the first installing base 113, and the welding blades 111 are rotatable relative to the first installing base 113 when the welding blades 111 are engaged with the welding head assembly 210, so that a back of each of the welding blades 111 is abutted against the limiting plates. Correspondingly, the welding heads 211 are also installed through an elastic connector to swing slightly around a rotating shaft with the second direction as an axial direction. When the welding heads 211 get closes to the respective welding blades 111, the welding heads 211 can press the respective welding blades 111 towards the first installing base 113, so that the engagement between the welding heads 211 and the respective welding blades 111 can be improved. This further enables the welding heads 211 to completely contact with the respective welding blades 111, thereby improving the welding quality of welding seams.

When welding a large-sized bed mesh 3000, a quantity of the welding head assembly 210 may be less than that of the welding blade assembly 110. In this case, a single engagement between the welding head assembly 210 and the welding blade assembly 110 may not achieve welding at all positions of the spring string 2000. Therefore, the welding head assembly 210 can be moved in the second direction for a plurality of times to complete the welding process. Specifically, in some embodiments, the welding head assembly 210 is movable in the second direction to allow the welding head assembly 210 to cooperate with welding blades 111 at different positions within the same welding blade mechanism 100. In this way, the welding head assembly 210 can be connected with the welding blades 111 at different positions for two or more times, achieving a plurality of times of welding in the second direction to complete the welding of an entire row of the spring string 2000.

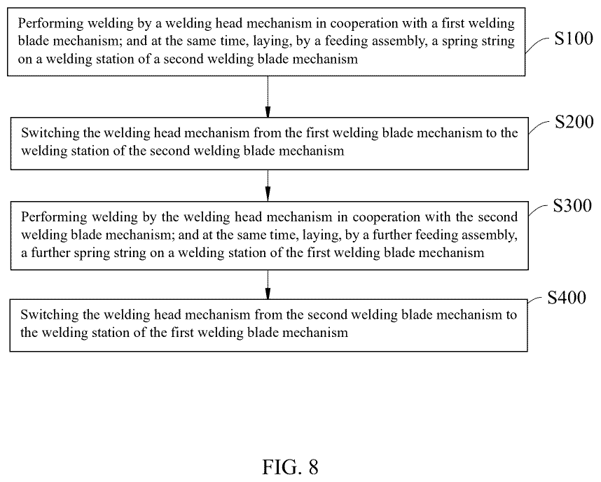

In a second aspect, referring to FIG. 8, the present disclosure provides a bed mesh assembly method, which can be realized by using the bed mesh assembly device 1000 provided in the first aspect. The bed mesh assembly method specifically includes:

S100. Performing welding by a welding head mechanism 200 in cooperation with a first welding blade mechanism; and at the same time, laying, by a loading assembly 400, a spring string 2000 on a welding station 101 of a second welding blade mechanism;

S200. Switching the welding head mechanism 200 from the first welding blade mechanism to the welding station 101 of the second welding blade mechanism;

S300. Performing welding by the welding head mechanism 200 in cooperation with the second welding blade mechanism; and at the same time, laying, by a further loading assembly 400, a further spring string 2000 on a welding station 101 of the first welding blade mechanism; and

S400. Switching the welding head mechanism 200 from the second welding blade mechanism to the welding station 101 of the first welding blade mechanism.

In a process of welding by the welding head mechanism 200 in cooperation with the first welding blade mechanism, the loading assembly 400 is used to lay the spring string 2000 on the second welding blade mechanism at the same time, so that an idle time of the welding station 101 of the second welding blade mechanism can be fully utilized. When the welding head mechanism 200 completes welding and is switched to the welding station 101 of the second welding blade mechanism, the welding head mechanism can perform welding with the second welding blade mechanism immediately without waiting for laying the spring string 2000, thus saving the waiting time, and improving the welding efficiency. Similarly, when the welding head mechanism 200 performs welding cooperatively with the second welding blade mechanism, the further loading assembly 400 lays the spring string 2000 on the first welding blade mechanism. Through such alternating operation, the welding head mechanism 200 and the loading assemblies 400 can always be in a working state, thus reducing the waiting time and improving the welding efficiency of a bed mesh 3000.

In some embodiments, performing welding by a welding head mechanism 200 in cooperation with a first welding blade mechanism in the step S100 includes:

S101. Performing welding by the welding head mechanism 200 in cooperation with one of the welding blade assemblies 110 of the first welding blade mechanism; and

S102. Performing welding by the welding head mechanism 200 in cooperation with another one of the welding blade assemblies 110 of the first welding blade mechanism.

Performing welding by the welding head mechanism 200 in cooperation with the second welding blade mechanism in the step S300 includes:

S301. Performing welding by the welding head mechanism 200 in cooperation with one of the welding blade assemblies 110 of the second welding blade mechanism; and

S302. Performing welding by the welding head mechanism 200 in cooperation with another one of the welding blade assemblies 110 of the second welding blade mechanism.

By alternately connecting the welding head mechanism 200 with two different welding blade assemblies 110 of the same welding blade mechanisms 100, the welding of different welding positions on the spring string 2000 can be realized, so that the spring bed mesh 3000 can be welded and formed.

In some embodiments, when a quantity of welding heads 211 of the welding head mechanism 200 is less than a quantity of welding blades 111 of the welding blade mechanism 100, performing welding by the welding head mechanism 200 in cooperation with the respective welding blade mechanism 100 includes:

S101. Performing welding by the welding head mechanism 200 in cooperation with a part of the welding blades 111 of the respective welding blade mechanism 100;

S102. Moving the welding head mechanism 200 in a second direction, and Performing welding by the welding head mechanism 200 in cooperation with remaining welding blades 111 of the respective welding blade mechanism 100; and

S103. repeating the previous step until the welding head mechanism performs welding in cooperation with all the welding blades 111.

In this way, the welding head assembly 210 is sequentially connected with the welding blades 111 at different positions in two or more passes, so as to realize a plurality of welding in the second direction to realize the welding of an entire row of the spring string 2000. Optionally, the bed mesh assembly device 1000 further includes a first rail 610 and a second driving component 620. The first rail 610 extends in the first direction, the welding head mechanism 200 is movably connected to the first rail 610, and the second driving component 620 may drive the welding head mechanism 200 to move along the first rail 610, so as to cooperate with the welding blades 111 at different positions for welding.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure. Moreover, in case of no conflict, the embodiments in the present disclosure and the features in the embodiments may be arbitrarily combined with each other.

What is claimed is:

1. A bed mesh assembly device, comprising:
a plurality of welding blade mechanisms arranged along a first direction, wherein one side of each of the welding blade mechanisms is formed with a welding station, each of the welding blade mechanisms comprises two welding blade assemblies, each of the welding blade assemblies comprises a plurality of welding blades extending along the first direction, the welding blades in a same welding blade assembly are spaced apart along a second direction, the welding blades in different welding blade assemblies are alternately arranged along the second direction to respectively correspond to positions between adjacent springs of a spring string, and the two welding blade assemblies alternately withdraw between two adjacent rows of the spring string and move to one side of the spring string near the welding station;
a welding head mechanism, wherein the welding head mechanism is movable along the first direction to any of the welding stations, the welding head mechanism comprises a plurality of welding head assemblies spaced apart along the second direction, and the welding head assemblies are capable of performing welding cooperatively with any of the welding blade assemblies; and
a loading assembly for moving along the second direction to convey the spring string to the welding station;
wherein the at least one loading assembly is configured to, in response to the welding head mechanism moving to any of the welding stations, convey the spring string to remaining welding stations.

2. The bed mesh assembly device according to claim 1, wherein the bed mesh assembly device comprises two loading assemblies and the loading assembly is one of the two loading assemblies, the plurality of welding blade mechanisms comprises two welding blade mechanisms, and the loading assemblies and the welding blade mechanisms are arranged in one-to-one correspondence.

3. The bed mesh assembly device according to claim 1, wherein the loading assembly comprises conveying parts, the conveying parts are arranged spaced apart in the second direction or a third direction in pairs, at least part of a loading channel is defined between the conveying parts in pairs, at least one of the conveying parts is a driving part, the driving part comprises at least one of a thumbwheel, a roller or a conveyor belt, and the driving part is movable to convey the spring string.

4. The bed mesh assembly device according to claim 3, wherein a distance between the conveying parts in pairs is adjustable to be suitable for spring strings with different diameters.

5. The bed mesh assembly device according to claim 3, wherein the loading assembly further comprises a guiding structure, the guiding structure is arranged on a loading side of the conveying parts, the guiding structure comprises two first guiding components which are arranged on both sides of the spring string along a radial direction of the springs, and a space between the two first guiding components is formed as the loading channel; and/or
the guiding structure comprises a second guiding component which is arranged on an end face of the spring string along the radial direction of the springs, and one side of the second guiding component facing the spring string is formed as a part of the loading channel.

6. The bed mesh assembly device according to claim 1, wherein each of the welding blade assemblies is movable in a third direction, and each of the welding blade assemblies is configured to push the spring string away from the welding head mechanism in the third direction in response to the welding blade assembly withdrawing from the spring string in the first direction and moving in the third direction to one side of the spring string facing the welding head mechanism.

7. The bed mesh assembly device according to claim 1, wherein the bed mesh assembly device further comprises a plurality of limiting assemblies, each of the limiting assemblies is arranged on one side of a respective one of the welding blade mechanisms away from the welding station along the third direction, surfaces of each of the limiting assemblies are formed as a forming channel for a welded bed mesh to pass through.

8. The bed mesh assembly device according to claim 7, wherein each of the limiting assemblies comprises a first bearing part and a second bearing part which are arranged at an interval along the first direction, the forming channel is defined between the first bearing part and the second bearing part, both the first bearing part and the second bearing part extend along the second direction, a distance between the first bearing part and the second bearing part is adjustable, and each of the welding blade assemblies is configured to be abutted against the respective first bearing part and the respective second bearing part in response to the welding head mechanism applying a force on the respective welding blade assembly.

9. The bed mesh assembly device according to claim 8, wherein each of the limiting assemblies further comprises a plurality of supporting parts arranged spaced apart along the second direction, the supporting parts are arranged on one side of each of the first bearing part and the second bearing part facing the welding head mechanism, the supporting parts are arranged in gaps between adjacent welding blades, the supporting parts extend into the welding station along the third direction, and the supporting parts are configured for accommodating the spring string laid by the loading assembly.

10. The bed mesh assembly device according to claim 9, wherein both the first bearing part and the second bearing part are limiting plates, the supporting parts are clamped to the limiting plates, and intervals of the plurality of supporting parts along the second direction are adjustable.

11. The bed mesh assembly device according to claim 10, wherein each of the welding blade assemblies comprises a first installing base and the plurality of welding blades, one end of each of the welding blades is rotatably connected to the first installing base, the welding blades are rotatable relative to the first installing base when the welding blades are engaged with the welding head assembly, and a back of each of the welding blades is abutted against the limiting plates, so that the welding blades are engaged with the welding head assembly.

12. The bed mesh assembly device according to claim 1, wherein the welding head assembly is movable in the second direction, so that the welding head assembly is able to perform welding at different positions in a same welding blade mechanism cooperatively with the welding blades at the different positions.

13. A bed mesh assembly method, comprising:
performing welding by a welding head mechanism in cooperation with a first welding blade mechanism; and at the same time, laying, by a loading assembly, a spring string on a welding station of a second welding blade mechanism;
switching the welding head mechanism from the first welding blade mechanism to the welding station of the second welding blade mechanism;
performing welding by the welding head mechanism in cooperation with the second welding blade mechanism; and at the same time, laying, by a further loading assembly, a further spring string on a welding station of the first welding blade mechanism; and
switching the welding head mechanism from the second welding blade mechanism to the welding station of the first welding blade mechanism.

14. The bed mesh assembly method according to claim 13, wherein the performing welding by a welding head mechanism in cooperation with a first welding blade mechanism comprises:
performing welding by the welding head mechanism in cooperation with one of welding blade assemblies of the first welding blade mechanism; and performing welding by the welding head mechanism in cooperation with another one of the welding blade assemblies of the first welding blade mechanism; and
the performing welding by the welding head mechanism in cooperation with the second welding blade mechanism comprises: performing welding by the welding head mechanism in cooperation with one of welding blade assemblies of the second welding blade mechanism; and
performing welding by the welding head mechanism in cooperation with another one of the welding blade assemblies of the second welding blade mechanism.

15. The bed mesh assembly method according to claim 13, wherein a quantity of welding heads of the welding head mechanism is less than a quantity of welding blades of the welding blade mechanism, performing welding by the welding head mechanism in cooperation with the respective welding blade mechanism comprises:
performing welding by the welding head mechanism in cooperation with a part of the welding blades of the respective welding blade mechanism;
moving the welding head mechanism in a second direction, and performing welding by the welding head mechanism in cooperation with remaining welding blades of the respective welding blade mechanism; and
repeating the previous step until the welding head mechanism performs welding in cooperation with all the welding blades.
